(19) United States
(12) Patent Application Publication
(10) Pub. No.: US 2020/0165746 A1
(43) Pub. Date: May 28, 2020

(54) SCALABLE AND FACILE IN SITU SYNTHESIS OF NANOPARTICLES RESULTING IN DECORATED MULTIFUNCTIONAL FIBERS

(71) Applicant: The Board of Regents of The University of Texas System, Austin, TX (US)

(72) Inventors: Karen Lozano, McAllen, TX (US); Mandana Akia, Albuquerque, NM (US)

(21) Appl. No.: 16/688,399

(22) Filed: Nov. 19, 2019

Related U.S. Application Data
(60) Provisional application No. 62/771,030, filed on Nov. 24, 2018.

(51) Int. Cl. D01D 5/06; D01D 5/18; D06M 10/00; D06M 11/83; D01F 9/21

(52) U.S. Cl. CPC D01D 5/06; D01D 5/18; B82Y 40/00; D06M 11/83; D01F 9/21; D06M 10/00

(57) ABSTRACT

Described herein is a method of in situ production of supported nanoparticles using centrifugal spinning to provide a composite fiber structure of polymer or carbon fibers having nanoparticles disposed on the surface. The nanoparticles may be salt particles or elemental metal particles.

### PRIORITY CLAIM

This application claims priority to U.S. Provisional Application Ser. No. 62/771,030 entitled “Scalable and facile in situ synthesis of nanoparticles resulting in decorated multifunctional fibers” filed Nov. 24, 2018, which is incorporated herein by reference in its entirety.

### STATEMENT REGARDING FEDERALLY SPONSORED RESEARCH OR DEVELOPMENT

This invention was made with government support under Grant No. NSF DMR 1523577 awarded by the National Science Foundation. The government has certain rights in the invention.

### BACKGROUND OF THE INVENTION

### 1. Field of the Invention

The present invention generally relates to the in-situ production of supported nanoparticles. More specifically, the invention relates to the formation and use of polymer fibers and carbon fibers as a support for nanoparticles.

### 2. Description of the Relevant Art

Nanoparticles, defined herein as particles having an average diameter of less than 1 micron, can be used in a variety of applications. One particularly useful application of nanoparticles is as catalysts. When nanoparticles are applied alone as catalysts (without loading on any support), it is difficult to recover the particles and reuse them or effectively dispose of the particles. Moreover, when the nanoparticles spread on a support with high surface area, more active sites are available due to higher dispersion of particles on the surface (no agglomeration) for possible reactions which result in better performance (increased stability).

The fabrication of homogenous distribution of nanoparticles on a support is a difficult task using conventional techniques. It is therefore desirable to find alternate techniques to form supported nanoparticles.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1A shows a top view of a fiber producing device and a collection wall;

FIG. 1B shows a projection view of a fiber producing device that includes a fiber producing device as depicted in FIG. 1A and a collection wall;

FIG. 2A shows a partially cut-away perspective view of an embodiment of a fiber producing system;

FIG. 2B depicts a cross-sectional view of a fiber producing system;

FIG. 3 depicts a schematic diagram of fiber formation using centrifugal spinning;

FIG. 4 depicts the schematic diagram of a heated fiber producing system;

FIG. 5A depicts a picture of NaCl nanoparticles and their distribution on a polymeric fiber support after low temperature heat treatment;

FIG. 5B depicts a picture of NaCl nanoparticles and their distribution on a carbon fiber support after high temperature heat treatment;

FIG. 6A depicts a picture of Ag nanoparticles and their distribution on a polymeric fiber support after low temperature heat treatment;

FIG. 6B depicts a picture of Ag nanoparticles and their distribution on a carbon fiber support after high temperature heat treatment.

FIG. 7A depicts a picture of Pt nanoparticles and their distribution on a polymeric fiber support after low temperature heat treatment; and

FIG. 7B depicts a picture of Pt nanoparticles and their distribution on a carbon fiber support after high temperature heat treatment.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### SUMMARY

In an embodiment, a method of in situ producing of supported nanoparticles, includes: placing a fiber producing composition comprising a polymer and a salt dissolved and/or suspended in a solvent into a body of a fiber producing device, the body comprising one or more openings; rotating the fiber producing device, wherein rotation of the fiber producing device causes the fiber producing composition in the body to be passed through one or more openings to produce polymer microfibers and/or polymer nanofibers comprising the salt; and heating at least a portion of the produced polypropylene microfibers and/or polypropylene nanofibers to a temperature sufficient to convert at least a portion of the salt into nanoparticles.

In one embodiment, the fibers are created without subjecting the fibers, during their creation, to an externally applied electric field.

In one embodiment, the polymer is a hydrophilic polymer. An exemplary hydrophilic polymer is polyvinylpyrrolidone. In one embodiment, the salt is an alkali metal salt or an alkaline earth metal salt. In one embodiment, the salt is a transition metal salt. The solvent used in the fiber forming composition may be a protic solvent.

The produced microfibers and/or nanofibers may be heated to a temperature between about 200° C. and about 500° C. The produced microfibers and/or nanofibers may be heated at this temperature for a time sufficient to produce nanoparticles of the salt on the fibers. In an alternate embodiment, the produced microfibers and/or nanofibers are heated to a temperature between about 550° C. and about 850° C. The produced microfibers and/or nanofibers are heated for a time sufficient to convert the polymer fibers into carbon fibers.

In one embodiment, a plurality of fibers is composed of carbon fibers having a plurality of nanoparticles on the exterior surface of the carbon fibers. In one embodiment, the nanoparticles are alkali metal salt or an alkaline earth metal salt. In another embodiment, the nanoparticles are transition metal nanoparticles.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a method or apparatus that “comprises,” “has,” “includes” or “contains” one or more steps or elements possesses those one or more steps or elements, but is not limited to possessing only those one or more steps or elements. Likewise, an element of an apparatus that “comprises,” “has,” “includes” or “contains” one or more features possesses those one or more features, but is not limited to possessing only those one or more features.

In an embodiment, a method of producing fibers as a support for in situ synthesis of nanoparticles includes placing a fiber producing composition comprising into a body of a fiber producing device, the body comprising one or more openings. The openings are sized such that when the material disposed in the body is ejected, the material will be formed into microfibers and/or nanofibers. As used herein the term “microfibers” refers to fibers having a diameter of less than 1 μm and greater than or equal to 1 μm. As used herein the term “nanofibers” refers to fibers having a diameter of less than 1 μm. The fibers are produced by rotating the fiber producing device, wherein rotation of the fiber producing device causes the fiber producing composition in the body to be passed through one or more openings to produce polymer microfibers and/or polymer nanofibers. As used herein this process is referred to as “centrifugal spinning.” The fiber producing device is rotated at a speed of at least about 500 rpm. Rotation of the fiber producing device causes the fiber producing composition in the body to be passed through one or more openings to produce polymer microfibers and/or polymer nanofibers. The polymer microfibers and/or polymer nanofibers are created without subjecting the polymer microfibers and/or polymer nanofibers, during their creation, to an externally applied electric field. Apparatuses and methods that may be used to create the polymer microfibers and/or polymer nanofibers are described in the following U.S. Published Patent Applications: 2009/0280325; 2009/0269429; 2009/0232920; and 2009/0280207, all of which are incorporated herein by reference.

In an embodiment, the fibers as a support for in situ synthesis of nanoparticles are formed from a hydrophilic polymer. Examples of hydrophilic polymers include, but are not limited to polyethylene oxide (PEO), ethylene oxide-propylene oxide co-polymers, polyethylene-polypropylene glycol (e.g. poloxamer), carbomer, polycarbophil, chitosan, polyvinyl pyrrolidone (PVP), polyvinyl alcohol (PVA), hydroxyalkyl celluloses such as hydroxypropyl cellulose (HPC), hydroxyethyl cellulose (HEC), hydroxymethyl cellulose and hydroxypropyl methylcellulose (HPMC), carboxymethyl cellulose, sodium carboxymethyl cellulose, methylcellulose, hydroxyethyl methylcellulose, hydroxypropyl methylcellulose, polyacrylates such as carbomer, polyacrylamides, polymethacrylamides, polyphosphazines, polyoxazolidines, and polyhydroxyalkylcarboxylic acids. One preferred polymer is polyvinylpyrrolidone.

Use of a hydrophilic polymer as the starting precursor for the formation of the fibers allows the solvent to be a protic solvent. As used herein the term “protic solvent” refers to any solvent that contains a labile H⁺. The molecules of such solvents readily donate protons (H⁺) to reagents. Typical protic solvents include solvents that have a hydrogen atom bound to an oxygen atom (as in a hydroxyl group) or a hydrogen atom bound to a nitrogen atom (as in an amine group). Protic solvents are, generally, safe, environmentally friendly, and cost effective.

The salts used may be an alkali metal salt, an alkaline earth metal salt, or a transition metal salt. In some embodiments the salt is stable throughout the process and the resulting nanoparticles are composed of the starting salt. In other embodiments, post-processing steps can convert the salt into an elemental metal. Typically, transition metal salts are used to prepare elemental metal nanoparticles through a heat decomposition treatment.

The produced polymer microfibers and/or polymer nanofibers are collected using a collection system. In some embodiments, the polymer microfibers and/or polymer nanofibers are collected as a mat of fibers. In other embodiments, the polymer microfibers and/or polymer nanofibers are collected by depositing the fibers onto a support.

After the composite fibers are produced, the fibers are heated to a temperature sufficient to convert at least a portion of the salt into nanoparticles. In one embodiment, the heat treatment is conducted at a temperature of between about 200° C. and about 500° C. The fibers are treated within this temperature range for a time sufficient to produce nanoparticles composed of the salt.

In another embodiment, the process may be used for in situ production of nanoparticles on carbon fiber supports. In this embodiment, the fibers produced during the centrifugal spinning method are heat treated at a temperature sufficient to convert the polymer fibers into carbon fibers. Typically, the temperatures range from about 550° C. to about 850° C.

The resulting products, typically, are nanoparticles distributed on polymeric fibers or carbon fibers. In some embodiments, the morphology of the nanoparticles may be altered by the heat treatment process. For example, it has been found that solid nanoparticles, formed when processed at the low temperature range (200° C. and about 500° C.) may change to hollow nanoparticles when processed at the high temperature range (550° C. to about 850° C.).

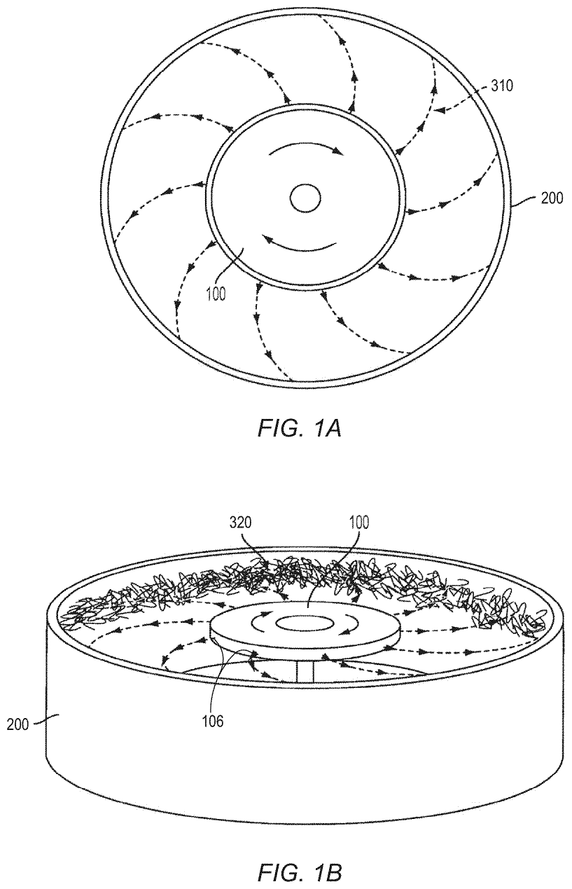

FIG. 1A shows a top view of an exemplary fiber producing system that includes a fiber producing device 100 and a collection wall 200. FIG. 1B shows a projection view of a fiber producing system that includes a fiber producing device 100 and a collection wall 200. As depicted, fiber producing device 100 is spinning clockwise about a spin axis, and material is exiting openings 106 of the fiber producing device as fibers 320 along various pathways 310. The fibers are being collected on the interior of the surrounding collection wall 200.

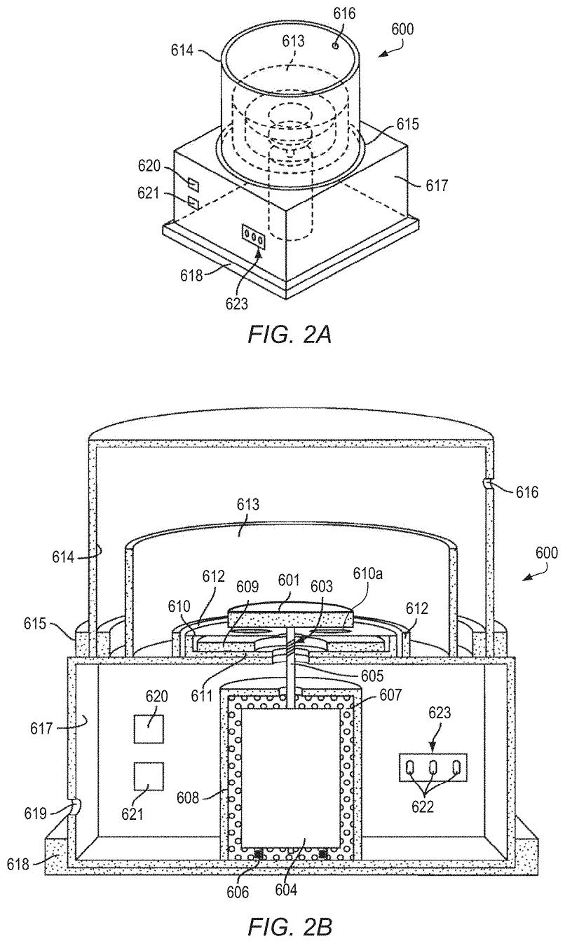

FIG. 2A shows a partially cut-away perspective view of an embodiment of a fiber producing system 600. FIG. 2B depicts a cross-sectional view of fiber producing system 600. System 600 includes fiber producing device 601, which has peripheral openings and is coupled to a threaded joint 603, such as a universal threaded joint, which, in turn, is coupled to a motor 604 via a shaft 605. Motor 604, such as a variable speed motor, is supported by support springs 606 and is surrounded by vibration insulation 607 (e.g., high-frequency vibration insulation). A motor housing 608 encases the motor 604, support springs 606 and vibration insulation 607. A heating unit 609 is enclosed within enclosure 610 (e.g., a heat reflector wall) that has openings 610a that direct heat (thermal energy) to fiber producing device 601. In the embodiment shown, heating unit 609 is disposed on thermal insulation 611. Surrounding the enclosure 610 is a collection wall 612, which, in turn, is surrounded by an intermediate wall 613. A housing 614 seated upon a seal 615 encases fiber producing device 601, heating enclosure 610, collection wall 612 and intermediate wall 613. An opening 616 in the housing 614 allows for introduction of fluids (e.g., gases such as air, nitrogen, helium, argon, etc.) into the internal environment of the apparatus, or allows fluids to be pumped out of the internal environment of the apparatus. The lower half of the system is encased by a wall 617 which is supported by a base 618. An opening 619 in the wall 617 allows for further control of the conditions of the internal environment of the apparatus. Indicators for power 620 and electronics 621 are positioned on the exterior of the wall 617 as are control switches 622 and a control box 623.

A control system of an apparatus 622 allows a user to change certain parameters (e.g., RPM, temperature, and environment) to influence fiber properties. One parameter may be changed while other parameters are held constant, if desired. One or more control boxes in an apparatus may provide various controls for these parameters, or certain parameters may be controlled via other means (e.g., manual opening of a valve attached to a housing to allow a gas to pass through the housing and into the environment of an apparatus). It should be noted that the control system may be integral to the apparatus (as shown in FIGS. 2A and 2B) or may be separate from the apparatus. For example, a control system may be modular with suitable electrical connections to the apparatus.

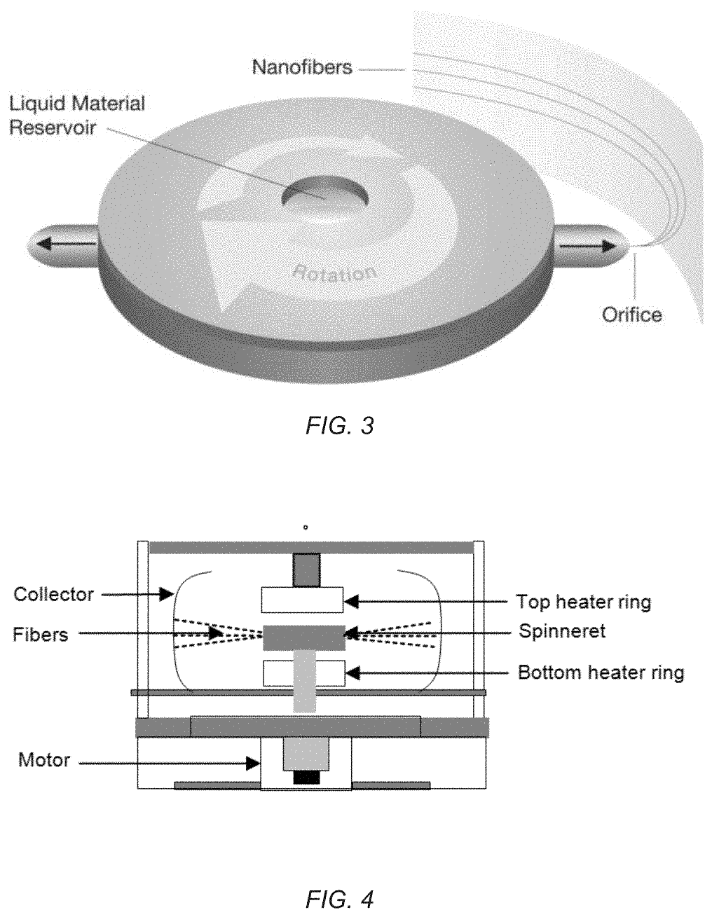

FIG. 3 shows a schematic diagram of fiber formation using centrifugal spinning. The polymer solution or melt are forced through the orifices of the spinneret by applying centrifugal force. As polymer solution or melt is ejected through the orifices, continuous polymer jets are formed and are stretched into formation of fine web of fibers due to applied centrifugal force and shear force acting across the tip of orifices of the spinneret.

The web is collected on a custom designed collector system. Fiber formation and morphology of the formed web are dictated by solution concentration (in case of solution spinning), melt viscosity (for melt spinning), rotational speed, distance between collection system and spinneret and gauge size of the spinneret. FIG. 4 shows the schematic diagram of a heated fiber producing system. The polymer was loaded onto the spinneret and was melted by engaging both upper and bottom heater rings.

In certain methods described herein, material spun in a fiber producing device may undergo varying strain rates, where the material is kept as a melt or solution. Since the strain rate alters the mechanical stretching of the fibers created, final fiber dimension and morphology may be significantly altered by the strain rate applied. Strain rates are affected by, for example, the shape, size, type and RPM of a fiber producing device. Altering the viscosity of the material, such as by increasing or decreasing its temperature or adding additives (e.g., thinner), may also impact strain rate. Strain rates may be controlled by a variable speed fiber producing device. Strain rates applied to a material may be varied by, for example, as much as 50-fold (e.g., 500 RPM to 25,000 RPM).

Temperatures of the material, fiber producing device and the environment may be independently controlled using a control system. The temperature value or range of temperatures employed typically depends on the intended application. For example, for many applications, temperatures of the material, fiber producing device and the environment typically range from −4° C. to 400° C. Temperatures may range as low as, for example, −20° C. to as high as, for example, 2500 C. For solution spinning, ambient temperatures of the fiber producing device are typically used.

As the material is ejected from the spinning fiber producing device, thin jets of the material are simultaneously stretched and dried in the surrounding environment. Interactions between the material and the environment at a high strain rate (due to stretching) lead to solidification of the material into polymeric fibers, which may be accompanied by evaporation of solvent. By manipulating the temperature and strain rate, the viscosity of the material may be controlled to manipulate the size and morphology of the polymeric fibers that are created. With appropriate manipulation of the environment and process, it is possible to form polymeric fibers of various configurations, such as continuous, discontinuous, mat, random fibers, unidirectional fibers, woven and unwoven, as well as fiber shapes, such as circular, elliptical and rectangular (e.g., ribbon). Other shapes are also possible. The produced fibers may be single lumen or multi-lumen.

By controlling the process parameters, fibers can be made in micron, sub-micron and nano-sizes, and combinations thereof. In general, the fibers created will have a relatively narrow distribution of fiber diameters. Some variation in diameter and cross-sectional configuration may occur along the length of individual fibers and between fibers.

Generally speaking, a fiber producing device helps control various properties of the fibers, such as the cross-sectional shape and diameter size of the fibers. More particularly, the speed and temperature of a fiber producing device, as well as the cross-sectional shape, diameter size and angle of the outlets in a fiber producing device, all may help control the cross-sectional shape and diameter size of the fibers. Lengths of fibers produced may also be influenced by fiber producing device choice.

The speed at which a fiber producing device is spun may also influence fiber properties. The speed of the fiber producing device may be fixed while the fiber producing device is spinning, or may be adjusted while the fiber producing device is spinning. Those fiber producing devices whose speed may be adjusted may, in certain embodiments, be characterized as “variable speed fiber producing devices.” In the methods described herein, the structure that holds the material may be spun at a speed of about 500 RPM to about 25,000 RPM, or any range derivable therein. In certain embodiments, the structure that holds the material is spun at a speed of no more than about 50,000 RPM, about 45,000 RPM, about 40,000 RPM, about 35,000 RPM, about 30,000 RPM, about 25,000 RPM, about 20,000 RPM, about 15,000 RPM, about 10,000 RPM, about 5,000 RPM, or about 1,000 RPM. In certain embodiments, the structure that holds the material is rotated at a rate of about 5,000 RPM to about 25,000 RPM.

In an embodiment, material may be positioned in a reservoir of the fiber producing device. The reservoir may, for example, be defined by a concave cavity of the fiber producing device. In certain embodiments, the fiber producing device includes one or more openings in communication with the concave cavity. The fibers are extruded through the opening while the fiber producing device is rotated about a spin axis. The one or more openings have an opening axis that is not parallel with the spin axis. The fiber producing device may include a body that includes the concave cavity and a lid positioned above the body such that a gap exists between the lid and the body, and the nanofiber is created as a result of the rotated material exiting the concave cavity through the gap.

Certain fiber producing devices have openings through which material is ejected during spinning. Such openings may take on a variety of shapes (e.g., circular, elliptical, rectangular, square, triangular, or the like) and sizes: (e.g., diameter sizes of 0.01-0.80 mm are typical). The angle of the opening may be varied between ±15 degrees. The openings may be threaded. An opening, such as a threaded opening, may hold a needle, where the needle may be of various shapes, lengths and gauge sizes. Threaded holes may also be used to secure a lid over a cavity in the body of a fiber producing device. The lid may be positioned above the body such that a gap exists between the lid and the body, and a fiber is created as a result of the spun material exiting the cavity through the gap. Fiber producing devices may also be configured such that one fiber producing device may replace another within the same apparatus without the need for any adjustment in this regard. A universal threaded joint attached to various fiber producing devices may facilitate this replacement. Fiber producing devices may also be configured to operate in a continuous manner.

Any method described herein may further comprise collecting at least some of the microfibers and/or nanofibers that are created. As used herein “collecting” of fibers refers to fibers coming to rest against a fiber collection device. After the fibers are collected, the fibers may be removed from a fiber collection device by a human or robot. A variety of methods and fiber (e.g., nanofiber) collection devices may be used to collect fibers. For example, regarding nanofibers, a collection wall may be employed that collects at least some of the nanofibers. In certain embodiments, a collection rod collects at least some of the nanofibers. The collection rod may be stationary during collection, or the collection rod may be rotated during collection.

Regarding the fibers that are collected, in certain embodiments, at least some of the fibers that are collected are continuous, discontinuous, mat, woven, unwoven or a mixture of these configurations. In some embodiments, the fibers are not bundled into a cone shape after their creation. In some embodiments, the fibers are not bundled into a cone shape during their creation. In particular embodiments, fibers are not shaped into a particular configuration, such as a cone figuration, using air, such as ambient air, that is blown onto the fibers as they are created and/or after they are created.

Present method may further comprise, for example, introducing a gas through an inlet in a housing, where the housing surrounds at least the fiber producing device. The gas may be, for example, nitrogen, helium, argon, or oxygen. A mixture of gases may be employed, in certain embodiments.

The environment in which the fibers are created may comprise a variety of conditions. For example, any fiber discussed herein may be created in a sterile environment. As used herein, the term “sterile environment” refers to an environment where greater than 99% of living germs and/or microorganisms have been removed. In certain embodiments, “sterile environment” refers to an environment substantially free of living germs and/or microorganisms. The fiber may be created, for example, in a vacuum. For example the pressure inside a fiber producing system may be less than ambient pressure. In some embodiments, the pressure inside a fiber producing system may range from about 1 millimeters (mm) of mercury (Hg) to about 700 mm Hg. In other embodiments, the pressure inside a fiber producing system may be at or about ambient pressure. In other embodiments, the pressure inside a fiber producing system may be greater than ambient pressure. For example the pressure inside a fiber producing system may range from about 800 mm Hg to about 4 atmospheres (atm) of pressure, or any range derivable therein.

In certain embodiments, the fiber is created in an environment of 0-100% humidity, or any range derivable therein. The temperature of the environment in which the fiber is created may vary widely. In certain embodiments, the temperature of the environment in which the fiber is created can be adjusted before operation (e.g., before rotating) using a heat source and/or a cooling source. Moreover, the temperature of the environment in which the fiber is created may be adjusted during operation using a heat source and/or a cooling source. The temperature of the environment may be set at sub-freezing temperatures, such as −20° C., or lower. The temperature of the environment may be as high as, for example, 2500° C.

The fibers that are created may be, for example, one micron or longer in length. For example, created fibers may be of lengths that range from about 1 μm to about 50 cm, from about 100 μm to about 10 cm, or from about 1 mm to about 1 cm. In some embodiments, the fibers may have a narrow length distribution. For example, the length of the fibers may be between about 1 μm to about 9 μm, between about 1 mm to about 9 mm, or between about 1 cm to about 9 cm. In some embodiments, when continuous methods are performed, fibers of up to about 10 meters, up to about 5 meters, or up to about 1 meter in length may be formed.

In certain embodiments, the cross-section of the fiber may be circular, elliptical or rectangular. Other shapes are also possible. The fiber may be a single-lumen lumen fiber or a multi-lumen fiber.

In another embodiment of a method of creating a fiber, the method includes: spinning material to create the fiber; where, as the fiber is being created, the fiber is not subjected to an externally-applied electric field or an externally-applied gas; and the fiber does not fall into a liquid after being created.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Experimental Method

### Materials

Polyvinylpyrrolidon (PVP) with average molecular weight of 1,300,000 (99.5%), silver nitrate solution (0.25 N), platinum (IV) nitrate solution and high purity isopropanol alcohol were purchased from Fisher Scientific Co. and used without modification. Sodium chloride (≥99.0%) was obtained from Sigma Aldrich Company.

### Methods:

PVP, solvent (e.g. a protic solvent such as water, isopropanol) and a salt precursor (sodium chloride, silver nitrate, or platinum (IV) nitrate in these experiments) were mixed and placed under stirring conditions at room temperature for 10 hours. The concentration of metal precursor to polymer was in a range of 0.5-4 wt %. The resulting fiber producing composition was spun applying a centrifugal spinning technique. The fabricated composite fibers were collected as a mat.

### Nanoparticles Supported on Polymeric Fibers

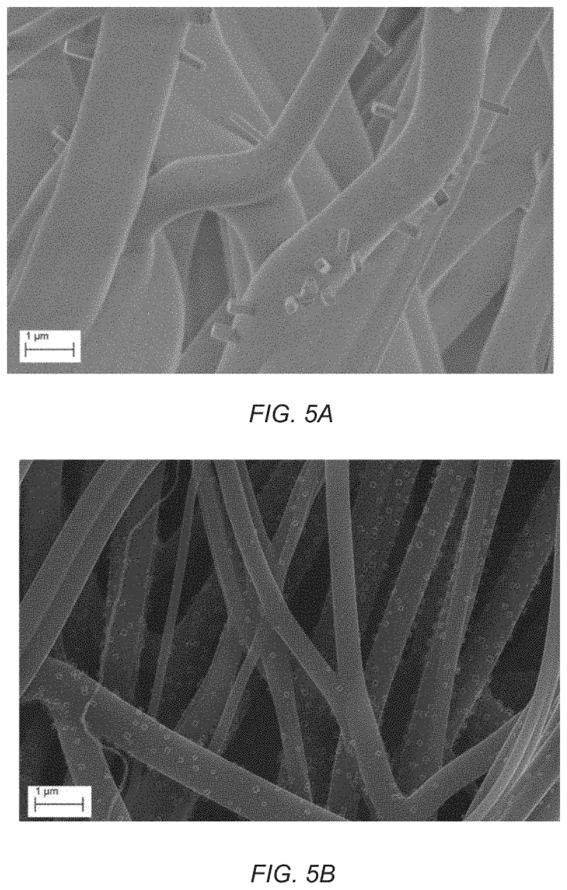

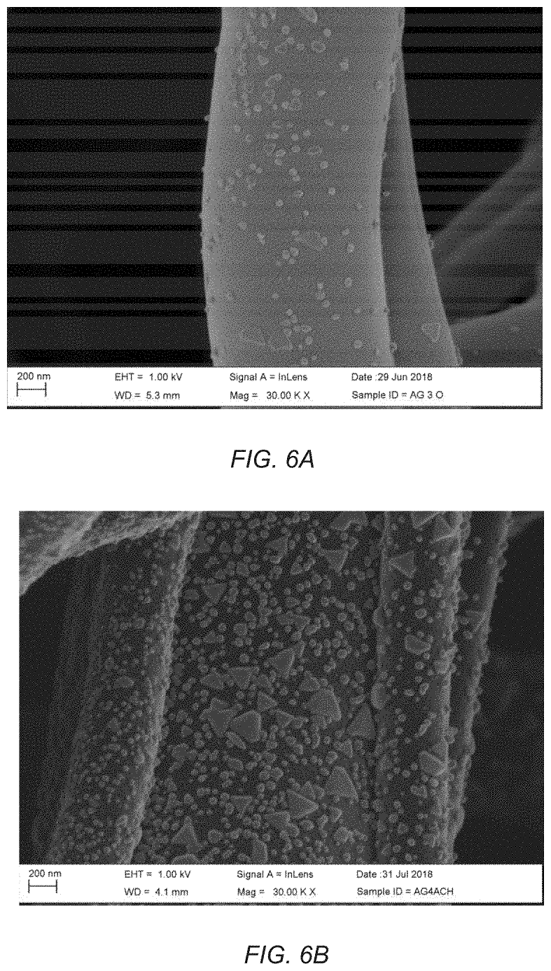

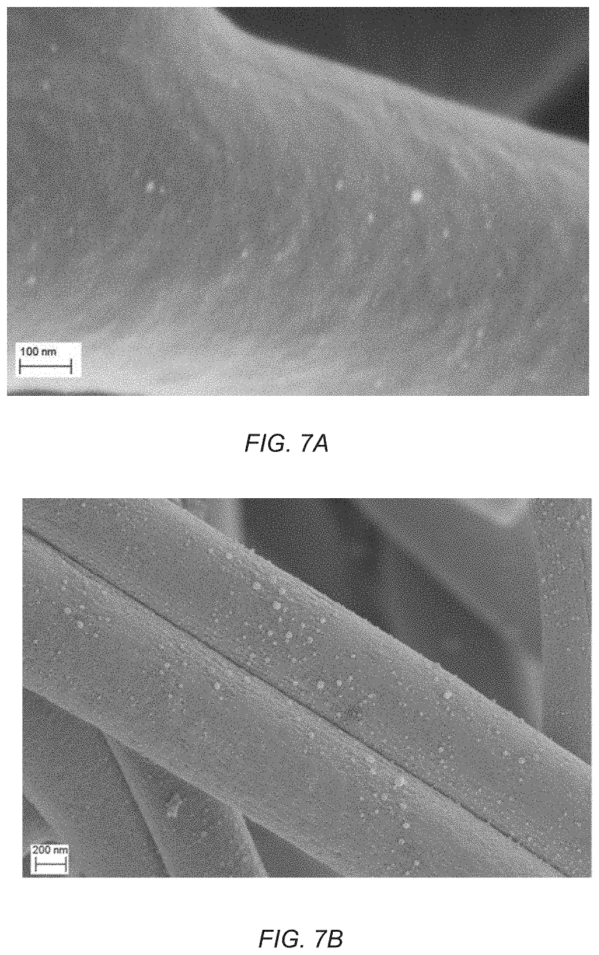

The collected composite fibers were heated in an oven at a temperature of 250° C. under air atmosphere. FIG. 5A depicts an SEM image of sodium chloride nanoparticles on polymeric (PVP) fibers after low temperature oven heat treatment. For the silver nitrate composite fibers, when the fibers are treated at temperatures above about 200° C., the silver nitrate decomposes into silver metal which is deposited onto the surface of the polymer fibers. FIG. 6A depicts an SEM image of silver nanoparticles on polymeric (PVP) fibers after low temperature oven heat treatment. FIG. 7A depicts an SEM image of platinum nanoparticles on polymeric (PVP) fibers after low temperature oven heat treatment.

### Nanoparticles Supported on Carbon Fibers

To obtain the unique carbon nanofibers composite structure, the oven treated sample was carbonized under nitrogen atmosphere at different temperatures of 550° C. and 850° C. (depending on the required shape and size) for 10 minutes. This process resulted in unique and a highly distributed nanocrystalline particles structure on a carbon fiber support. FIG. 5B depicts an SEM image of sodium chloride nanoparticles on carbon fibers after carbonization of the polymer (PVP). The carbonization process changed the morphology of the sodium chloride nanoparticles from a solid particle into a hollow nanocube structure. FIG. 6B depicts an SEM image of silver nanoparticles on carbon fibers after carbonization of the polymer (PVP). FIG. 7B depicts an SEM image of platinum nanoparticles on carbon fibers after carbonization of the polymer (PVP)

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of in situ production of supported nanoparticles, comprising:
placing a fiber producing composition comprising a polymer and a salt dissolved and/or suspended in a solvent into a body of a fiber producing device, the body comprising one or more openings;
rotating the fiber producing device, wherein rotation of the fiber producing device causes the fiber producing composition in the body to be passed through one or more openings to produce polymer microfibers and/or polymer nanofibers comprising the salt;
heating at least a portion of the produced polymeric microfibers and/or polymeric nanofibers to a temperature sufficient to convert at least a portion of the salt into nanoparticles.

2. The method of claim 1, wherein the fibers are created without subjecting the fibers, during their creation, to an externally applied electric field.

3. The method of claim 1, wherein the polymer is a hydrophilic polymer.

4. The method of claim 1, wherein the polymer is a hydrophobic polymer.

5. The method of claim 1, wherein the polymer is polyvinylpyrrolidone.

6. The method of claim 1, wherein the salt is an alkali metal salt or an alkaline earth metal salt.

7. The method of claim 1, wherein the salt is a transition metal salt.

8. The method of claim 1, wherein the solvent is a protic solvent.

9. The method of claim 1, wherein the produced microfibers and/or nanofibers are heated to a temperature between about 200° C. and about 500° C.

10. The method of claim 8, wherein the produced microfibers and/or nanofibers are heated for a time sufficient to produce nanoparticles of the salt on the fibers.

11. The method of claim 1, wherein the produced microfibers and/or nanofibers are heated to a temperature between about 550° C. and about 850° C.

12. The method of claim 1, wherein the produced microfibers and/or nanofibers are heated for a time sufficient to convert the polymer fibers into carbon fibers.

13. A plurality of carbon fibers comprising a plurality of nanoparticles on the exterior surface of the carbon fibers.

14. The fibers of claim 13, wherein the nanoparticles are alkali metal salt or an alkaline earth metal salt.

15. The fibers of claim 13, wherein the nanoparticles are transition metal nanoparticles.

16. The fibers of claim 13, wherein the carbon fibers are carbon microfibers.

17. The fibers of claim 13, wherein the carbon fibers are carbon nanofibers.

18. The fibers of claim 13, wherein the nanoparticles are hollow nanoparticles.
